(19) United States
(12) Patent Application Publication
(10) Pub. No.: US 2020/0097985 A1
(43) Pub. Date: Mar. 26, 2020

(54) SYSTEM AND METHOD FOR MODELLING ORGANIC SELLABILITY OF FASHION PRODUCTS

(71) Applicant: Myntra Designs Private Limited, Muneshwara Nagar (IN)

(72) Inventors: Sumit Borar, Bangalore (IN); Vikram Garg, Jaipur (IN); Anoop Rajagopal, Bangalore (IN); Rajdeep Hazra Banerjee, Bangalore (IN)

(21) Appl. No.: 16/266,690

(22) Filed: Feb. 4, 2019

(30) Foreign Application Priority Data
Sep. 25, 2018 (IN) 201841036007

(51) Int. Cl. G06Q 30/02; G06N 7/00; G06N 20/00

(52) U.S. Cl. CPC G06Q 30/0201; G06N 20/00; G06N 7/005; G06Q 30/0206

(57) ABSTRACT

A system and method for determining organic sellability of fashion products is provided. The system includes a memory having computer-readable instructions stored therein. The system further includes a processor configured to access a plurality of fashion images of a plurality of fashion products. The processor is configured to acquire sales data corresponding to each of the plurality of fashion products. The processor is further configured to identify one or more substantially similar fashion styles of the fashion products based upon the plurality of fashion images and attributes corresponding to the fashion products. In addition, the processor is configured to create one or more training sets having pairs of the identified similar fashion styles. Each of the similar fashion styles is associated with corresponding merchandising features. The processor is configured to normalize each of the pairs of identified similar fashion styles based upon the merchandising features and sales data using visual similarity constraints to determine normalizing parameters for each of the pairs. Furthermore, the processor is configured to determine a sale potential score for each of the training sets using the respective normalizing parameters. Moreover, the processor is configured to generate a sellability prediction model using the one or more training sets based upon the merchandising features and sales potential and estimate sales potential of a plurality of new styles using the sellability prediction model.

### PRIORITY STATEMENT

The present application claims priority under 35 U.S.C. § 119 to Indian patent application number 201841036007 filed 25 Sep. 2018, the entire contents of which are hereby incorporated herein by reference.

### FIELD

The invention relates generally to a system for modelling organic sales potential or sellability of fashion products, and more particularly to a system and method for determining organic sellability of visual aesthetics of a variety of fashion styles available for sale on a fashion e-commerce website.

### BACKGROUND

A variety of e-commerce websites offer fashion products suitable for consumers with varied fashion interests. In general, such websites have a variety of fashion products available in different styles. It may be difficult to predict sales potential of the fashion products owing to large variation in consumers interests that in-turn may be dependent on demography, fashion trends etc. As a result, it may be difficult for the manufacturers to predict the sellability of the fashion products resulting in difficulties in effectively managing inventory for such products.

Currently, some fashion e-commerce websites use sales prediction techniques that involve grading of fashion products based on their platform merchandising values (e.g. Gross Margin, Revenue, entities sold etc.). These techniques may not consider effects of the visual aspects of the fashion products.

Certain other personalized recommendation techniques are based on visual features and item affinity of the fashion products. Some of these techniques use time aware and visual aware modelling. However, it is difficult to estimate selling potential of the fashion products using such techniques. Other available techniques rely on non-visual attributes such as color, fabric and price buckets. These techniques estimate purchase probabilities of the fashion products based on customer to product recommendations and do not provide accurate estimation of the sales potential or the sellability of the fashion products.

Thus, there is a need to provide a system that can provide accurate measure of sales potential for fashion products such as sold using an e-commerce platform.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description. Example embodiments provide a system and method for determining organic sellability of fashion products.

Briefly, according to an example embodiment, system for determining organic sellability of fashion products is provided. The system includes a memory having computer readable instructions stored therein. The system further includes a processor configured to access a plurality of fashion images of a plurality of fashion products. The processor is configured to acquire sales data corresponding to each of the plurality of fashion products. The processor is further configured to identify one or more substantially similar fashion styles of the fashion products based upon the plurality of fashion images and attributes corresponding to the fashion products. In addition, the processor is further configured to create one or more training sets having pairs of the identified similar fashion styles. Each of the similar fashion styles is associated with corresponding merchandising features. Furthermore, the processor is configured to normalize each of the pairs of identified similar fashion styles based upon the merchandising features and sales data using visual similarity constraints to determine normalizing parameters for each of the pairs. Moreover, the processor further configured to determine a sale potential score for each of the training sets using the respective normalizing parameters. The processor is further configured to generate a sellability prediction model using the one or more training sets based upon the merchandising features and sales potential. In addition, the processor is configured to estimate sales potential of a plurality of new styles using the sellability prediction model.

According to another example embodiment, system for determining organic sellability of fashion products is provided. The system includes a memory having computer readable instructions stored therein and a processor configured to access a plurality of fashion images of a plurality of fashion products. The processor is configured to acquire sales data corresponding to each of the plurality of fashion products. The processor is further configured to identify one or more substantially similar fashion styles of the fashion products based upon the plurality of fashion images and attributes corresponding to the fashion products. In addition, the processor is configured to create one or more training sets having pairs of the identified similar fashion styles. Each of the similar fashion styles is associated with corresponding merchandising features. The processor is configured to define normalizing parameters associated with each of the merchandising features of each of the pairs to account for merchandising and brand bias on sellability of the fashion products. The processor is configured to define a pricing model for each training set using the merchandising features, sales data and the normalizing parameters associated with the merchandising features for each training set. Further, the processor is configured to apply visual similarity constraints to the pricing model to achieve a substantially similar sales potential score for each training set. The processor is configured to estimate the normalizing parameters and a sales potential score for each training set using the pricing model.

According to another example embodiment, a method for determining organic sellability of fashion products is provided. The method includes accessing a plurality of fashion images of a plurality of fashion products and acquiring sales data corresponding to each of the plurality of fashion products. In addition, the method includes identifying one or more substantially similar fashion styles of the fashion products based upon the plurality of fashion images and attributes corresponding to the fashion products. The method includes forming one or more training sets, each training set having pairs of the identified similar fashion styles. Each of the similar fashion styles is associated with corresponding merchandising features. The method further includes defining normalizing parameters associated with each of the merchandising features of each of the pairs to account for merchandising and brand bias on sellability of the fashion products. In addition, the method includes defining a pricing model for each training set using the merchandising features, sales data and the normalizing parameters associated with the merchandising features for each training set. Moreover, the method includes applying visual similarity constraints to the pricing model to achieve a substantially similar sales potential score for each training set and estimating the normalizing parameters and a sales potential score for each training set using the pricing model

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 illustrates a block diagram illustrating a system for determining organic sellability of fashion products, according to an example embodiment;

FIG. 2 is an example process for determining organic sellability of fashion products, using the system of FIG. 1, according to the aspects of the present technique;

FIG. 3-A shows images of similar looking style of top wear with same attribute (i.e. base-colour) and having different sales data and merchandising features;

FIG. 3-B shows images of similar looking style of top wear with same attributes (i.e. base-colour and brand) and having different average selling price; and

FIG. 4 is a block diagram of an embodiment of a computing device in which the modules of the system for determining organic sellability of fashion products, described herein, are implemented.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed but may also have additional steps not included in the figure. The processes may correspond to methods, functions, procedures, subroutines, subprograms, etc.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the scope of inventive concepts.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in ‘addition to the orientation depicted in the figures. For example, if the device in the figures is turned over, elements described as “below” or “beneath” other elements or features would then be oriented “above” the other elements or features. Thus, term such as “below” may encompass both an orientation of above and below. The device may be otherwise oriented (rotated 90 degrees or at other orientations) and the spatially relative descriptors used herein are interpreted accordingly.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The device(s)/apparatus(es), described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer-readable storage media.

The methods according to the above-described example embodiments of the inventive concept may be implemented with program instructions which may be executed by computer or processor and may be recorded in computer-readable media. The media may also include, alone or in combination with the program instructions, data files, data structures, and the like. The program instructions recorded in the media may be designed and configured especially for the example embodiments of the inventive concept or be known and available to those skilled in computer software. Computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher-level codes that may be executed by the computer using an interpreter. The described hardware devices may be configured to execute one or more software modules to perform the operations of the above-described example embodiments of the inventive concept, or vice versa.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

At least one example embodiment is generally directed to a system for determining organic sellability of fashion products such as available for sale on an e-commerce platform. As used herein, the term “organic sellability” refers to sellability of the fashion products that is normalized for various merchandising factors such as maximum retail price (MRP), discounts, visibility and brand effects introduced on an e-commerce platform.

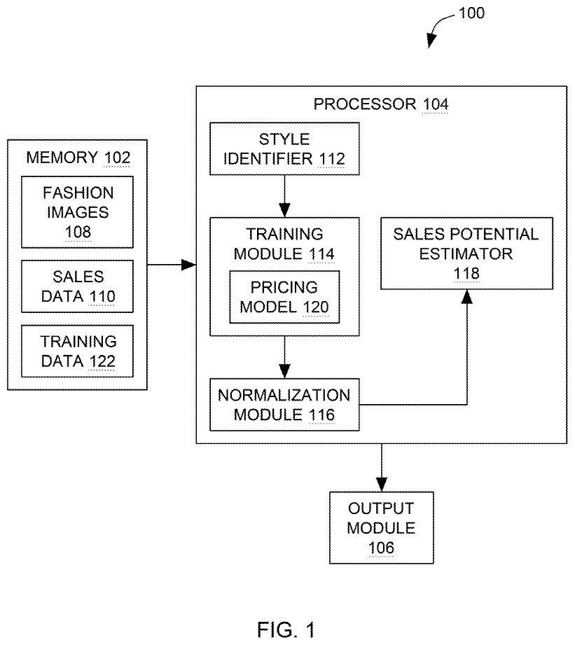

FIG. 1 is a block diagram illustrating a system 100 for determining organic sellability of fashion products. The system 100 includes a memory 102, a processor 104 and an output module 106. Each component is described in further detail below.

As illustrated, the processor 104 is communicatively coupled to the memory 102 and is configured to access fashion images 108 of a plurality of fashion products. The processor 104 may be configured to access these fashion images 108 from the memory 102. The fashion images 108 may be images of fashion products purchased by a plurality of users via an e-commerce fashion platform. The fashion images 108 may include images of a top wear, a bottom wear, foot wear, bags, or combinations thereof. Moreover, the processor 104 may be configured to access sales data 110 corresponding to each of the plurality of fashion products from the memory 102. The sales data 110 may include style identification data, quantity sold, revenue, maximum retail price (MRP), discounts, average selling price (ASP), average click through rate (CTR) on the e-commerce platform, list count, or combinations thereof for each of the fashion products.

In certain embodiments, the processor 104 may be configured to analyse at the total sales of a product in a [symbol] category (e.g.: Men's T-Shirts) over a period of time such as in a period of three months, considering only those styles which are live on the platform for a minimum time period (e.g., 30 days). As used herein, the term average click through rate refers to a ratio of the number of clicks on the product page and total listings of the fashion product. Further, the term “average selling price” refers to the price after accounting for applicable discounts of the product averaged over a time window.

In this embodiment, the processor 104 includes a style identifier 112, a training module 114, a normalization module 116, and a sales potential estimator 118. The style identifier 112 is configured to identify one or more substantially similar fashion styles of the fashion products based upon the plurality of fashion images 108 and attributes corresponding to the fashion products. Such attributes of the fashion products may include, but are not limited to, shape, color, fit type, design elements, structure, edges, or combinations thereof, of each of the fashion products.

Further, the training module 114 is configured to create one or more training sets having pairs of the identified similar fashion styles. Here, each of the similar fashion styles may be associated with corresponding merchandising features. As used herein, the term “merchandising features” refers to features that affect the fashion styles and are defined for each fashion style based on past data. Examples of such merchandising features may include, but are not limited to, a product brand, maximum retail price (MRP) of the fashion product, discounts available for the fashion product, list counts, user preferences, seasonality, brand affinity, or combinations thereof. In some embodiments, such training sets may be stored in the memory 102 as training data 122.

The normalization module 116 is configured to normalize each of the pairs of identified similar fashion styles based upon the merchandising features and sales data 110, using visual similarity constraints to determine normalizing parameters for each of the pairs of the similar fashion styles. In this embodiment, the training module 114 is further configured to define a pricing model 120 for each of the training sets using the merchandising features, sales data 110 and normalizing parameters associated with the merchandising features.

In one example, the normalization module 116 is configured to apply visual similarity constraints to the pricing model 120 to achieve a substantially similar sales potential score for each training set. In this example, the normalization module 116 is configured to apply visual similarity constraints to the similar styles in accordance with the relationship:

min γⱼₖ (1)

where: j and k are visually similar looking styles; and

γⱼₖ=|log(SPⱼ)−log(SPₖ)|

In one embodiment, the normalization module 116 is configured to normalize each of the pairs of identified similar styles to achieve substantially similar sales potential for the identified similar styles of each pair. In one example, the normalization module 116 is configured to normalize the similar styles in accordance with the relationship:

(Πᵢ₌ₙ^{d}fᵢⱼ^{α}^{ⁱ})SPⱼ=Qⱼ (2)

where Qⱼ is quantity sold of a fashion style j;

fᵢ is merchandising bias based on the merchandising features; and

αⁱ is a normalizing parameter.

The sales potential estimator 118 is configured to determine a sale potential score for each of the training sets using the respective normalizing parameters. The sales potential estimator 118 is further configured to estimate the sales potential of a plurality of new styles using the sellability prediction model.

In one embodiment, sales potential estimator 118 is configured to generate a sellability prediction model using the one or more training sets based upon the merchandising features and the sales potential. In this embodiment, the sales potential estimator 118 is configured to generate a sellability prediction model in accordance with the relationship:

β^{T}f_{vgg}=SP (3)

where: β^{T} is the weighting parameter;

SP is the sales potential; and

f_{vgg} is image feature of the fashion styles.

The sales potential estimator 118 is further configured to generate recommendations for top selling fashion products and to facilitate assortment planning of the fashion products based upon the estimated sales potential of new fashion styles. In certain embodiments, the sales potential estimator 118 is further configured to rank the fashion styles based upon the estimated sales potential. Such generate recommendations and the rankings of the fashion styles along with the assortment planning details may be displayed to a user via the output module 106. Moreover, the sales potential estimator 118 is may be configured to predict likeability and sellability of a plurality of fashion styles listed on one or more e-commerce platforms.

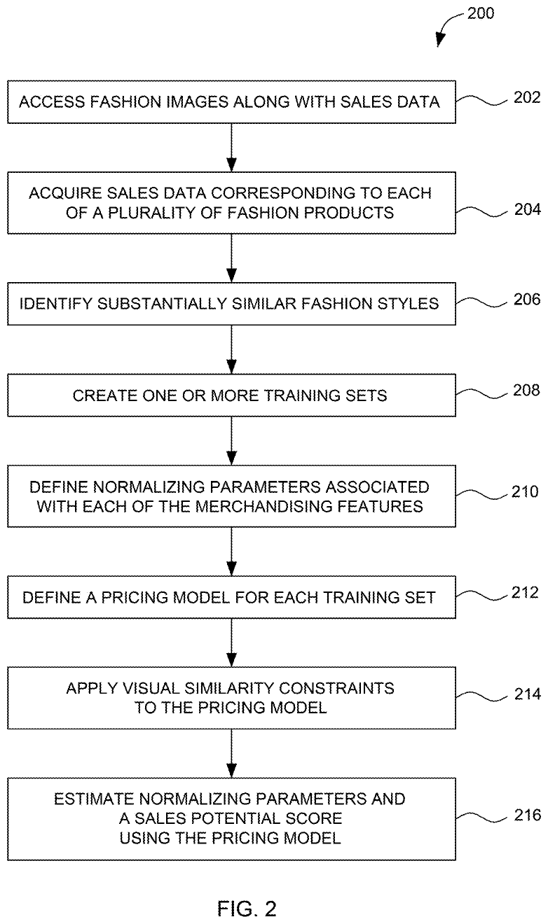

FIG. 2 is an example process 200 for determining organic sellability of fashion products, using the system of FIG. 1, according to the aspects of the present technique.

At block 202, a plurality of fashion images of a plurality of fashion products are accessed. In an embodiment, the fashion images may include images of a top wear, a bottom wear, foot wear, bags and the like. In some embodiments, the fashion images are accessed from a memory device configured to store the fashion images. These images are associated with sales data corresponding to each of the plurality of fashion products. At block 204, such sales data is acquired. The sales data may include style identification data, quantity sold, revenue, maximum retail price (MRP), discounts, average selling price (ASP), average click through rate (CTR) on the e-commerce platform, list count, or combinations thereof for each of the fashion products.

At block 206, one or more substantially similar fashion styles of the fashion products are identified. The similar fashion styles are identified based upon the plurality of fashion images and attributes corresponding to the fashion products. Such attributes may include, but are not limited to, shape, color, fit type, design elements, structure, edges, or combinations thereof, of each of the fashion products.

At block 208, one or more training sets are formed, each training set having pairs of the identified similar fashion styles. Each of the similar fashion styles is associated with corresponding merchandising features.

At block 210, normalizing parameters associated with each of the merchandising features of each of the pairs are defined. In this embodiment, such normalizing parameters are defined to account for effect of merchandising and brand bias on sellability of the fashion products.

At block 212, a pricing model for each of the training sets is defined using the merchandising features, sales data and the normalizing parameters associated with the merchandising features for each training set. In one embodiment, the pricing model may be defined, in accordance with the relationship:

(Πᵢ₌ₙ^{d}fᵢⱼ^{α}^{ⁱ})SPⱼ=Qⱼ (2)

where Qⱼ is quantity sold of a fashion style j;

fᵢ is merchandising bias based on the merchandising features; and

αⁱ is a normalizing parameter.

At block 214, visual similarity constraints are applied to the pricing model to achieve a substantially similar sales potential score for each training set.

Further, at block 216 the normalizing parameters and a sales potential score are estimated for each training set using the pricing model such as described above. Here, the estimated sales potential score is indicative of a comparison for the fashion product relative to other products in the same category with respect to sellability of the fashion product.

In certain embodiments, a sellability prediction model is generated using the one or more training sets based upon the merchandising features, the normalizing parameters and the sales potential. Further, the sales potential of new styles may be estimated using the sellability prediction model.

As described in FIGS. 1 and 2 above, the current technique facilitates grading of looks of the fashion products using parameters such as sales potential while normalizing the effects of merchandising factors like discounts, price, list views and brand effects introduced in the e-commerce platform that in influences buyer's behaviour.

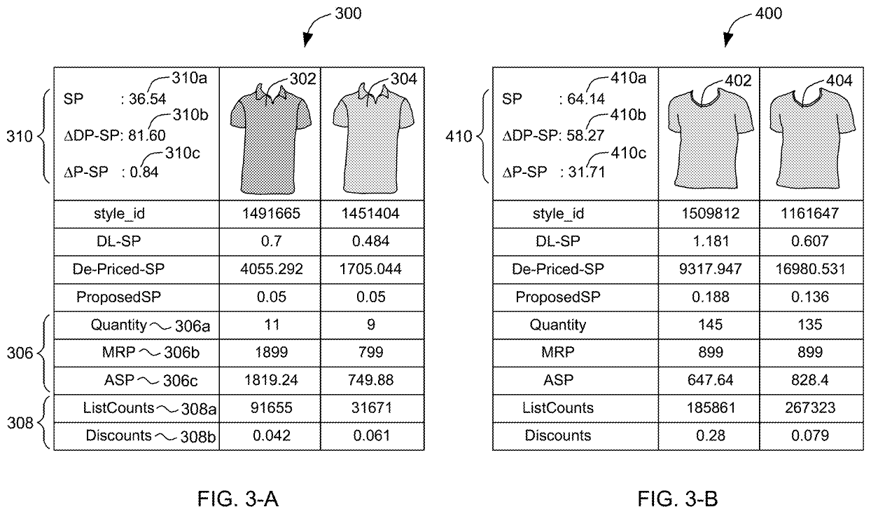

FIGS. 3-A and 3-B illustrate comparison of selling prices of similar fashion styles 300 and 400 of exemplary fashion products. Images 300 and 400 illustrates pairs of visually similar styles with varying merchandising features as observed on e-commerce platform.

FIG. 3-A shows images 300 of similar looking style of top wear such as generally represented by reference numerals 302 and 304, with same attribute (i.e. base-colour) and having different sales data 306 and merchandising features 308. In this example, sales data 306 include quantity 306a, MRP 306b and ASP 306c. Moreover, the merchandising features 308 include list counts 308a and discounts 308b. As can be seen, owing to different sales data 306, selling score (shown in tab 310) estimated for these similar looking styles are relatively different. In this embodiment, the sales potential score (SP) may be obtained in accordance with the relationship:

β^{T}f_{vgg}=SP

where: β^{T} is the weighting parameter;

SP is the sales potential; and

f_{vgg} is image feature of the fashion styles.

Here, using normalized parameters of the two styles 302 and 304, a sales potential score (SP) of about 37% is achieved as indicated by reference numeral 310a

The selling score with normalized sales potential (DP-SP), is estimated to be about 82% as indicated by reference numeral 310b. In one embodiment, the selling score with normalized sales potential (DP-SP), may be calculated in accordance with the relationship:

$$DP \text{-} SP = \frac{Revenue}{log ( 1 + \frac{Listcounts}{1000} )} {( \frac{ASP}{MRP} )}^{2} \qquad ( 4 )$$

Moreover, using power law model and by applying the image similarity constraint as described above with reference to FIGS. 1 and 2, the proposed selling score (P-SP) is estimated to be about 0.84% as shown with numeral reference 310c. In one example, the normalization module 116 is configured to normalize the similar styles in accordance with the relationship:

(Πᵢ₌ₙ^{d}fᵢⱼ^{α}^{ⁱ})SPⱼ=Qⱼ

where Qⱼ is quantity sold of a fashion style j;

fᵢ is merchandising bias based on the merchandising features; and

αⁱ is a normalizing parameter.

Similarly, FIG. 3-B shows images of similar looking style of top wear generally represented by reference numerals 402 and 404, with same attributes (i.e. base-colour and brand), but having different average selling price. As can be seen, proposed selling price (P-SP) 410c has significantly lesser percentage difference (about 31.71) as compared to selling score with normalized sales potential (DP-SP) 410a (about 58.27) and sales potential score (SP) 410b (about 64.14). The current technique by imposing similarity constraint thus better normalizes for the biases inherent in the ecommerce platform.

As can be seen, the current technique facilitates determining a sales potential score for fashion products by applying visual similarity constraints to normalize the effects of merchandising factors like discounts, price, list views and brand effects. Moreover, the fashion products may be ranked based on the estimated sales potential. The ranking of the fashion products obtained using the technique described above may be used to facilitate rich diversity and freshness of products by refreshing the catalogue with fashion products that may be trending in different social/e-commerce platforms. The grading of the products on the e-commerce platforms may facilitate substitutions and buying decisions during sale events organized on the platform.

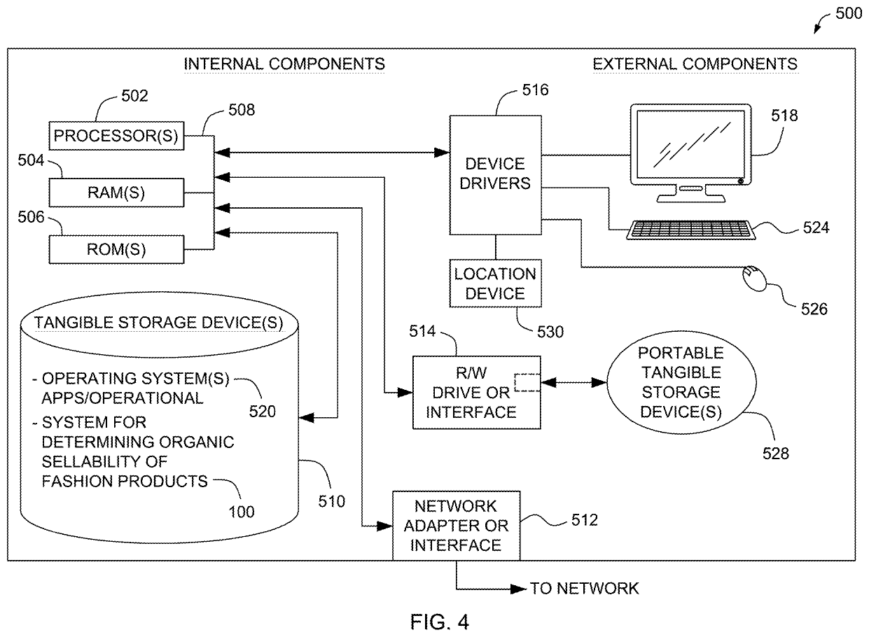

The modules of system 100 for determining organic sellability of fashion products described herein are implemented in computing devices. One example of a computing device 500 is described below in FIG. 4. The computing device includes one or more processor 502, one or more computer-readable RAMs 504 and one or more computer-readable ROMs 506 on one or more buses 508. Further, computing device 500 includes a tangible storage device 510 that may be used to execute operating systems 520 and the system 100. The various modules of the system 100 include a processor 104, a memory 102 and an output module 106. The processor 104 further includes a style identifier 112, a training module 114, a normalization module 116 and a sale potential estimator 118. Both, the operating system 520 and the system 100 are executed by processor 502 via one or more respective RAMs 504 (which typically include cache memory). The execution of the operating system 520 and/or the system 100 by the processor 502, configures the processor 502 as a special purpose processor configured to carry out the functionalities of the operation system 520 and/or the system 100, as described above.

Examples of storage devices 510 include semiconductor storage devices such as ROM 506, EPROM, flash memory or any other computer-readable tangible storage device that may store a computer program and digital information.

Computing device also includes a R/W drive or interface 514 to read from and write to one or more portable computer-readable tangible storage devices 528 such as a CD-ROM, DVD, memory stick or semiconductor storage device. Further, network adapters or interfaces 512 such as a TCP/IP adapter cards, wireless Wi-Fi interface cards, or 3G or 4G wireless interface cards or other wired or wireless communication links are also included in computing device.

In one example embodiment, the system 100 which includes a processor 104, a memory 102 and an output module 106, may be stored in tangible storage device 510 and may be downloaded from an external computer via a network (for example, the Internet, a local area network or other, wide area network) and network adapter or interface 512.

Computing device further includes device drivers 516 to interface with input and output devices. The input and output devices may include a computer display monitor 518, a keyboard 524, a keypad, a touch screen, a computer mouse 526, and/or some other suitable input device.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other exemplary features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Haskell, Go, SQL, R, Lisp, Java®, Fortran, Perl, Pascal, Curl, OCaml, Javascript®, HTMLS, Ada, ASP (active server pages), PHP, Scala, Eiffel, Smalltalk, Erlang, Ruby, Flash®, Visual Basic®, Lua, and Python®.

1. A system for determining organic sellability of fashion products, the system comprising:
a memory having computer-readable instructions stored therein; and
a processor configured to:
access a plurality of fashion images of a plurality of fashion products;
acquire sales data corresponding to each of the plurality of fashion products;
identify one or more substantially similar fashion styles of the fashion products based upon the plurality of fashion images and attributes corresponding to the fashion products;
create one or more training sets having pairs of the identified similar fashion styles, wherein each of the similar fashion styles is associated with corresponding merchandising features;
normalize each of the pairs of identified similar fashion styles based upon the merchandising features and sales data using visual similarity constraints to determine normalizing parameters for each of the pairs;
determine a sale potential score for each of the training sets using the respective normalizing parameters;
generate a sellability prediction model using the one or more training sets based upon the merchandising features and sales potential;
estimate sales potential of a plurality of new styles using the sellability prediction model.

2. The system of claim 1, wherein the processor is further configured to execute the computer-readable instructions to acquire sales data of fashion products sold from an e-commerce platform, wherein the sales data comprises style identification data, quantity sold, revenue, maximum retail price (MRP), discounts, average selling price (ASP), average click through rate (CTR) on the e-commerce platform, listcount, or combinations thereof for each of the fashion products.

3. The system of claim 1, wherein the processor is further configured to execute the computer-readable instructions to identify the one or more similar fashion styles based upon image similarity and the corresponding attributes, wherein the attributes comprise shape, color, fit type, design elements, structure, edges, or combinations thereof of each of the fashion products.

4. The system of claim 1, wherein the processor is further configured to execute the computer-readable instructions to identify the merchandising features for each of the fashion products, wherein the merchandising features comprise a product brand, maximum retail price (MRP) of the fashion product, discounts available for the fashion product, listcounts, user preferences, seasonality, brand affinity or combinations thereof.

5. The system of claim 1, wherein the processor is further configured to execute the computer-readable instructions to normalize each of the pairs of identified similar styles to achieve substantially similar sales potential for the identified similar styles of each pair.

6. The system of claim 5, wherein the processor is further configured to execute the computer-readable instructions to normalize the similar styles in accordance with the relationship:
(Πᵢ₌ₙ^{d}fᵢⱼ^{α}^{ⁱ})SPⱼ=Qⱼ
where Qⱼ is quantity sold of a fashion style j;
fᵢ is merchandising bias based on the merchandising features; and
αⁱ is a normalizing parameter.

7. The system of claim 6, wherein the processor is further configured to execute the computer-readable instructions to apply visual similarity constraints to the similar styles in accordance with the relationship:
min γⱼₖ
where; j and k are visually similar looking styles; and
γⱼₖ=|log (SPⱼ)−log (SPₖ)|.

8. The system of claim 7, wherein the processor is further configured to execute the computer-readable instructions to generate a sellability prediction model in accordance with the relationship:
β^{T}f_{vgg}=SP
where β^{T} is the weighting parameter;
SP is the sales potential; and
f_{vgg} is image features of the fashion styles.

9. The system of claim 1, wherein the processor is further configured to execute the computer-readable instructions to access a plurality of fashion images of a top wear, a bottom wear, foot wear, bags, or combinations thereof available for sale on an online ecommerce platform.

10. The system of claim 1, wherein the processor is further configured to execute the computer-readable instructions to generate recommendations for top selling fashion products and to facilitate assortment planning of the fashion products based upon the estimated sales potential of new fashion styles.

11. The system of claim 10, wherein the processor is further configured to execute the computer-readable instructions to rank the fashion styles based upon the estimated sales potential.

12. The system of claim 10, wherein the processor is further configured to execute the computer-readable instructions to predict likeability and sellability of a plurality of fashion styles listed on one or more e-commerce platforms.

13. A system for determining organic sellability of fashion products, the system comprising:
a memory having computer-readable instructions stored therein; and
a processor configured to:
access a plurality of fashion images of a plurality of fashion products;
acquire sales data corresponding to each of the plurality of fashion products;
identify one or more substantially similar fashion styles of the fashion products based upon the plurality of fashion images and attributes corresponding to the fashion products;
create one or more training sets, each training set having pairs of the identified similar fashion styles, wherein each of the similar fashion styles is associated with corresponding merchandising features;
define normalizing parameters associated with each of the merchandising features of each of the pairs to account for merchandising and brand bias on sellability of the fashion products;
define a pricing model for each training set using the merchandising features, sales data and the normalizing parameters associated with the merchandising features for each training set;
apply visual similarity constraints to the pricing model to achieve a substantially similar sales potential score for each training set; and
estimate the normalizing parameters and a sales potential score for each training set using the pricing model.

14. The system of claim 13, wherein the processor is further configured to execute the computer-readable instructions to:
generate a sellability prediction model using the one or more training sets based upon the merchandising features, the normalizing parameters associated with the merchandising features and the sales potential;
estimate sales potential of a plurality of new styles using the sellability prediction model.

15. The system of claim 13, wherein the processor is further configured to execute the computer-readable instructions to acquire sales data of fashion products sold from an e-commerce platform, wherein the sales data comprises style identification data, quantity sold, revenue, maximum retail price (MRP), discounts, average selling price (ASP), average click through rate (CTR) on the e-commerce platform, listcount, or combinations thereof for each of the fashion products.

16. The system of claim 13, wherein the processor is further configured to execute the computer-readable instructions to identify the merchandising features for each of the fashion products, wherein the merchandising features comprise a product brand, maximum retail price (MRP) of the fashion product, discounts available for the fashion product, listcounts, user preferences, seasonality, brand affinity or combinations thereof.

17. The system of claim 13, wherein the processor is further configured to execute the computer-readable instructions to define the pricing model in accordance with the relationship:
(Πᵢ₌ₙ^{d}fᵢⱼ^{α}^{ⁱ})SPⱼ=Qⱼ
where Qⱼ is quantity sold of a fashion style j;
fᵢ is merchandising bias based on the merchandising features; and
αⁱ is a normalizing parameter.

18. The system of claim 13, wherein the processor is further configured to execute the computer-readable instructions to generate the sellability prediction model in accordance with the relationship:
β^{T}=SP
where β^{T} is the weighting parameter;
SP is the sales potential; and
f_{vgg} is image features of the fashion styles.

19. A method for determining organic sellability of fashion products, the method comprising:
accessing a plurality of fashion images of a plurality of fashion products;
acquiring sales data corresponding to each of the plurality of fashion products;
identifying one or more substantially similar fashion styles of the fashion products based upon the plurality of fashion images and attributes corresponding to the fashion products;
forming one or more training sets, each training set having pairs of the identified similar fashion styles, wherein each of the similar fashion styles is associated with corresponding merchandising features;
defining normalizing parameters associated with each of the merchandising features of each of the pairs to account for merchandising and brand bias on sellability of the fashion products;
defining a pricing model for each training set using the merchandising features, sales data and the normalizing parameters associated with the merchandising features for each training set;
applying visual similarity constraints to the pricing model to achieve a substantially similar sales potential score for each training set; and
estimating the normalizing parameters and a sales potential score for each training set using the pricing model.

20. The method of claim 19, further comprising:
generating a sellability prediction model using the one or more training sets based upon the merchandising features, the normalizing parameters associated with the merchandising features and the sales potential;
estimating sales potential of a plurality of new styles using the sellability prediction model.
